(19) United States
(12) Patent Application Publication
(10) Pub. No.: US 2002/0124022 A1
(43) Pub. Date: Sep. 5, 2002

(54) Method and apparatus for processing web documents using multi-browse function

(76) Inventor: Chin-woo Yoo, Seoul (KR)

Correspondence Address: J.C. PATENTS INC., Suite 250, 4 Venture, Irvine, CA, 92618, US

(21) Appl. No.: 09/901,543

(22) Filed: Jul. 9, 2001

(30) Foreign Application Priority Data
Dec. 29, 2000 (KR) 2000-86368

(51) Int. Cl. G06F 17/24; G06F 17/21; G06F 17/00; G06F 15/00

(52) U.S. Cl. 707/513

(57) ABSTRACT

A method and apparatus for processing web documents, according to which a plurality of web documents are multi-browsed by managing the documents in an incorporated way, are provided. The web document processing method for incorporating and browsing a plurality of web documents at a terminal connected to a server through a network includes the steps of: obtaining web documents including at least a primary document; obtaining one or more secondary web documents specified in the primary document; storing data of the secondary web documents in corresponding predetermined storing portions; displaying document selectors associated with the secondary web documents on a screen of the terminal; and upon selecting one of the document selectors, displaying a secondary web document corresponding to a selected document selector on the screen of the terminal. Accordingly, the web processing method and apparatus enable users to view a plurality of documents or search results without moving from one web page to another, thereby saving surfing time on the Internet and increasing effective use of the Internet.

### BACKGROUND OF THE INVENTION

1. Field of the Invention

The present invention relates to a method and apparatus for processing web documents using a multi-browse function, and more particularly, to a web document method and apparatus for multi-browsing a plurality of web documents by managing the documents in an incorporated way.

2. Description of the Related Art

The World Wide Web (WWW) is a wide-area hypermedia information retrieval system that enables users to globally access web information through hypertext computer servers and clients on a network. Hypertext is a type of text that allows embedded links to other documents. Clicking on a hypertext link directs a user to another document. A hypertext page (or web page) consisting of hypertexts may contain multimedia objects such as text, graphics (pictures), audio, and animation.

Web pages on the World Wide Web are accessed by browsers such as Microsoft's Internet Explorer or Netscape Communication's Navigator to appear on the screen. Most web browsers have been designed to view one document in one web browser window. FIG. 1 shows a conventional browser. A web browser program is run to display the browser of FIG. 1 on the screen. Entering a site address in a location window displays a web page of the site in a browser window 50. In FIG. 1, reference numeral 10 denotes the name of a relevant browser or site and reference numeral 20 denotes a menu for performing a browsing function. Reference numeral 30 denotes a portion for performing page transition functions of the web page such as “back”, “forward”, “stop” and “reload”. Reference numeral 60 denotes a work status line for displaying a work state, and reference numeral 70 denote a Windows work status line including a Windows start button for performing the browser program. Reference numerals 11, 12, and 13 represent buttons for minimizing the web page, converting the web page into a window or maximizing it, or and closing the web page in the browser, respectively. For the browser, each web document has a unique web address called Uniform Resource Locator (URL). A current web document is navigated to another document through the input of this address or a hypertext link. Thus, in order to refer to several web documents at once, several browser windows must be displayed on the screen. Although browsers solving the above problem have been designed, the browsers must be downloaded separately and may not be fully compatible with most commonly used browsers. Accordingly, it would be highly desirable to have a method and apparatus for displaying a plurality of documents together on the screen using conventional browsers most commonly used. However, since the conventional browser has only one location window as shown in FIG. 1, it is not possible to display a plurality of documents together on the screen.

### SUMMARY OF THE INVENTION

To solve the above problems, it is an object of the present invention to provide a method and apparatus for processing web documents using a multi-browse function, according to which a plurality of web documents are managed in an incorporated way and multi-browsed.

It is another object of the present invention to provide a method and apparatus for processing web documents using a multi-browse function, according to which a plurality of results processed on the basis of information provided from a user are multi-browsed by managing the documents in an incorporated way.

It is another object of the present invention to provide a computer-readable recording medium on which a method for multi-browsing a plurality of web documents by managing the documents in an incorporated way is recorded.

It is another object of the present invention to provide a web browser having a function of multi-browsing a plurality of web documents by managing them in an incorporated way.

It is another object of the present invention to provide a method and apparatus for processing web documents using a multi-browse function, which are applied to a PC-based client-server system, a web TV, personal digital assistant (PDA) and a web phone to read one or more documents or retrievals at once using one browser in order to store them and to select one of the documents or retrievals in order to browse it.

Accordingly, to achieve the above objects, the present invention provides a web document processing method for multi-browsing a plurality of web documents at a terminal connected to a server through a network. The method includes the steps of: obtaining web documents including at least a primary document; obtaining one or more secondary web documents specified in the primary document; storing data of the secondary web documents in corresponding predetermined storing portions; displaying document selectors associated with the secondary web documents on a screen of the terminal; and upon selecting one of the document selectors, displaying a secondary web document corresponding to a selected document selector on the screen of the terminal.

The present invention also provides an apparatus for web document processing having a multi-browse function. The apparatus includes: a module for obtaining web documents containing at least a primary document; a module for obtaining one or more secondary web documents specified in the primary document; a module for storing data of the secondary web documents in corresponding predetermined storing portions; a module for displaying document selectors in association with the secondary web documents on a screen of the terminal; and a module for displaying a secondary web document stored in the corresponding storing portion corresponding to one of the document selectors selected on the screen of the terminal.

The present invention also provides a computer-readable recording medium on which a web document processing method is recorded. The method includes the steps of: obtaining web documents including at least a primary document; obtaining one or more secondary web documents specified in the primary document; storing data of the secondary web documents in corresponding predetermined storing portions; displaying document selectors associated with the secondary web documents on a screen of the terminal; and upon selecting one of the document selectors, displaying a secondary web document corresponding to the selected document selector on the screen of the terminal.

### BRIEF DESCRIPTION OF THE DRAWINGS

The above objects and advantages of the present invention will become more apparent by describing in detail preferred embodiments thereof with reference to the attached drawings in which:

FIG. 1 is an example of a conventional web browser screen;

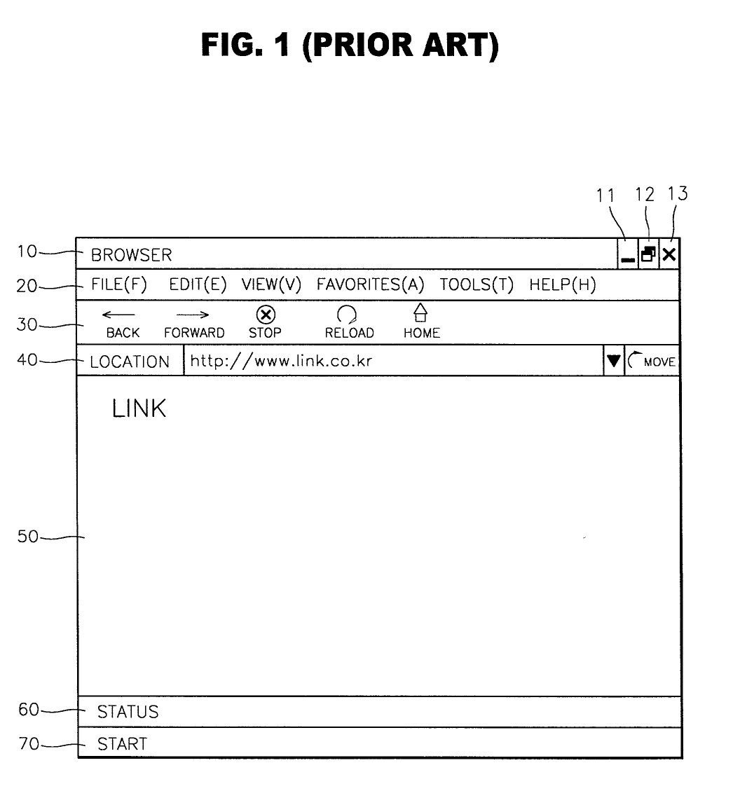

FIG. 2 is a schematic diagram of a web document processing apparatus having a multi-browse function according to the present invention;

FIG. 3 is a flowchart of a web document processing method using a multi-browse function according to a first embodiment of the present invention;

FIG. 4 is an example of a multi-browser screen according to a first embodiment of the present invention;

FIG. 5 is an example of a multi-link location creation screen according to a first embodiment of the present invention;

FIG. 6 is a flowchart of a web document processing method using a multi-browse function according to a second embodiment of the present invention; and

FIG. 7 is an example of a multi-browser screen according to a second embodiment of the present invention.

### DETAILED DESCRIPTION OF THE INVENTION

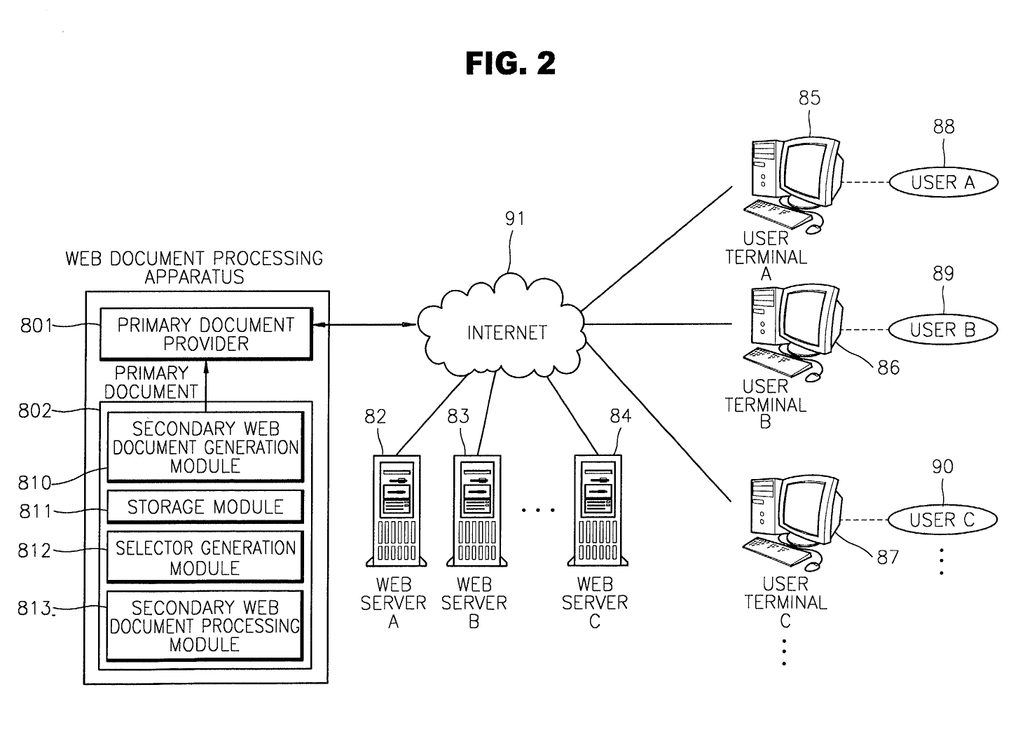

Referring to FIG. 2, a user A 88, a user B 89, and a user C 90 (hereinafter called users 88, 89, and 90) employ a user terminal A 85, a user terminal B 86, and a user terminal C 87 (hereinafter called user terminals 85, 86, and 87), respectively, to be connected to a web document processing apparatus 80 according to the present invention through the Internet 91. The web document processing apparatus 80 provides multi-browsing environments to each of the user terminals 85, 86, and 87 which allows them to simply and quickly access a plurality of web documents. To accomplish this, the web document processing apparatus 80 includes a primary document 802 containing a web program for performing a web document processing method according to the present invention and a prima primary document provider 801 for providing the primary document 802 to the user terminals 85, 86, and 87. The primary document 802 is provided to the user terminals 85, 86, and 87 in the form of a URL. The primary document 802 includes a secondary web document generation module 810 for obtaining one or more secondary web documents specified in the primary document 802, a storage module 811 for storing data of the obtained secondary web documents in corresponding predetermined storing portions, a document selector generation module 812 for generating document selectors associated with the secondary web documents and displaying the generated document selectors on the screen of each of the user terminals 85, 86, and 87 and a secondary web document processing module 813 for performing creation/erasure/switching functions on each of the secondary web documents.

Each of the modules 810, 811, 812, and 813 is transmitted to the user terminals 85, 86, and 87 through the Internet 91 in the form of a web program contained in the primary document 802 and executed. The primary document 802 is written in a web programming language such as Hypertext Markup Language (HTML) including scripts, Professional HTML Preprocessor (PHP), Active Server Pages (ASP), or Extensible Markup Language (XML) to execute the primary document at the user terminals 85, 86, and 87. Also, the modules 810, 811, 812, and 813 may be installed into the user terminals 85, 86, and 87 in the form of separate executable files and executed. The secondary web document generation module 810 is controlled by the primary document 802 for obtaining one or more secondary web documents from web servers 82, 83, and 84. The secondary web document may include multimedia objects such as graphic (still) images, audio, and animation, as well as web documents written in HTML(or dynamic HTML) including a script language, PHP, ASP, Java Server Pages (JSP), or XML. The obtained secondary web documents are stored in a storage medium of the user terminals 85, 86, and 87 such as memory HDD, a floppy disc, and a CD-RW through the storage module 811. The document selector generation module 812 generates document selectors associated with the secondary web documents fetched from the web servers 82, 83, and 84 in order to display the document selectors on the screen of each of the user terminals 85, 86, and 87. The secondary web document processing module 813 performs management functions such as creating, erasing, and switching on the secondary web documents. The secondary web documents may be stored in objects such as frame, inline frame (IFRAME), layer, division, and span. In this case, the objects perform display functions of the secondary web documents.

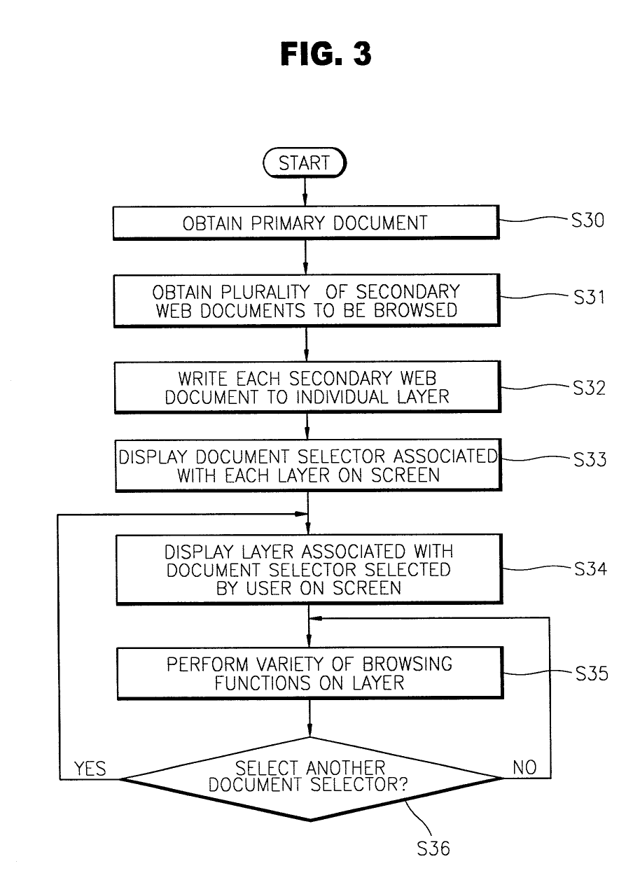

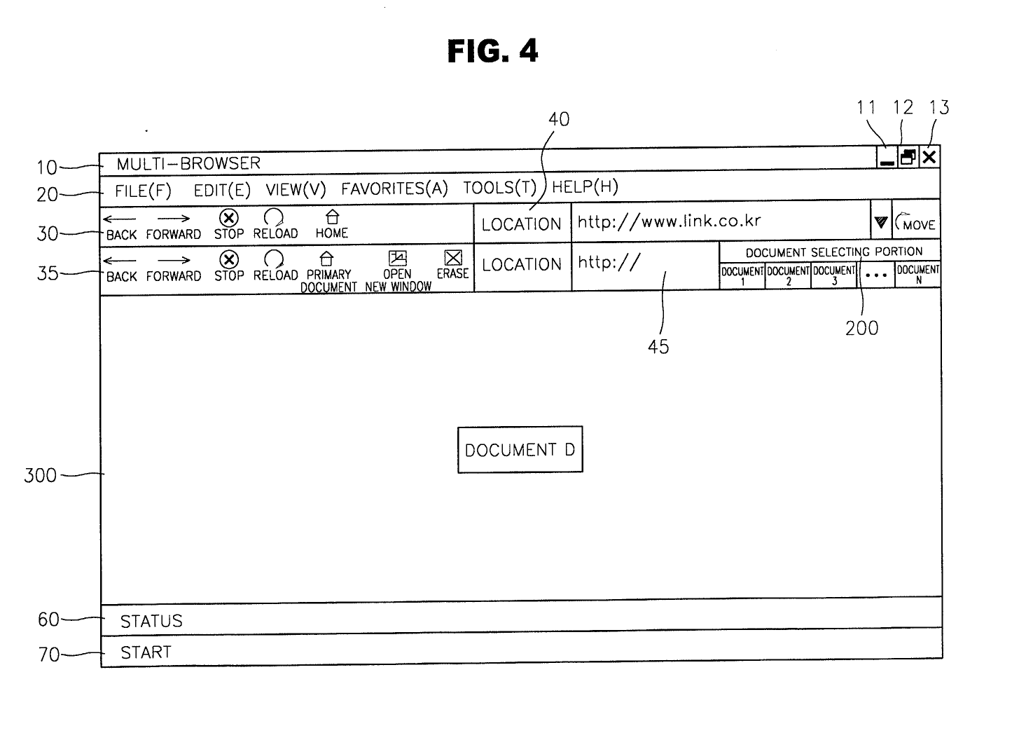

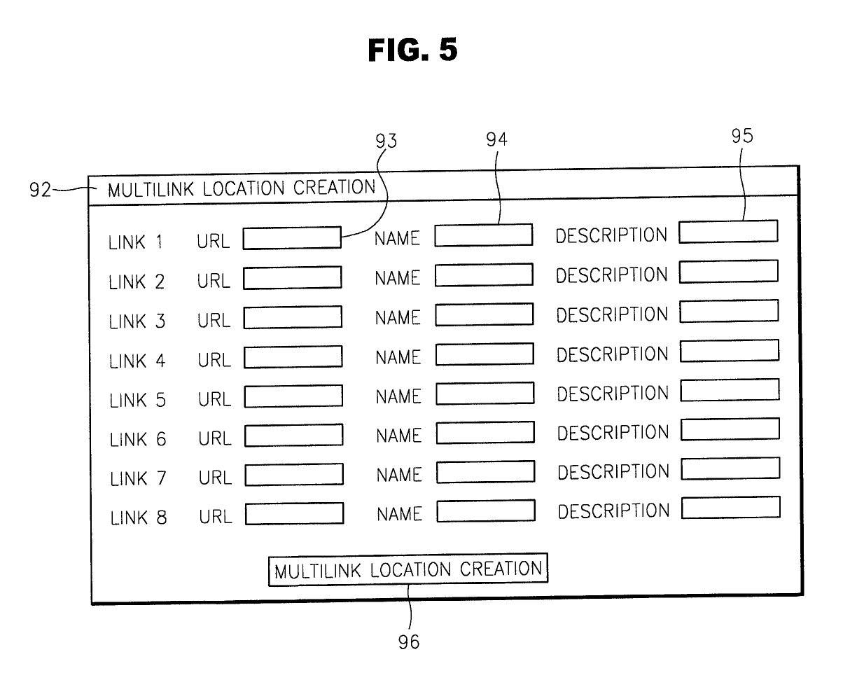

A method for implementing a multi-browse function performed by the web document processing apparatus 80 will now be described with reference to FIGS. 3 and 4. FIG. 3 is a flowchart of a method for web document processing using a multi-browse function according to a first embodiment of the present invention, and FIG. 4 is an example of a multi-browser screen according to a first embodiment of the present invention. First, a server for providing a primary document is connected to obtain the primary document (step S30). Then, a plurality of secondary web documents to be browsed is obtained (step S31). The obtained secondary web documents are divided into two types of documents: those predesignated by the web document processing apparatus 80 or the users 88, 89, and 90 and those designated by the users 88, 89, and 90 during browsing. The former type of documents are provided by classifying in advance main web sites frequently visited by the users by topics (for example, IT information, sports, economy, and history, etc.) in the web document processing apparatus 80 or by the users+ registering web documents frequently visited by themselves 88, 89, and 90. A process for the users+ registering web documents frequently visited by themselves will be described below with reference to FIG. 5. The latter type of documents are obtained by directly entering the URL of the web site into an additional location window 45 during web surfing instead of selecting the secondary web documents to be browsed using the document selectors registered in a document selecting portion 200.

The secondary web documents may be designated by the users 88, 89, and 90 during browsing with a click of a hypertext linked to an appropriate web document to obtain the web document or may be designated according to an input result submitted through an input form contained in a predetermined web document. To perform these functions, information representing that the linked web document will be processed by the web document processing apparatus 80 as well as information about the link to the web document may be attached to the hypertext to the document. The information representing that the linked web document will be processed by the web document processing apparatus 80 may be defined by designating tags in a predefined form in an anchor for the hypertext. Alternatively, if the user clicks on a hypertext within a web document, the web document processing apparatus 80 may process the web document in real time to obtain a document linked to the hypertext. It will be understood by those skilled in the art that this invention may be embodied in many other forms. Obtaining the secondary web documents with a click of a hyperlink will be effective for selecting desired articles from a news list and multi-browsing them.

If the plurality of secondary web documents are obtained in the step S31, each of the plurality of secondary web documents is stored in an individual storing portion allocated in a storing medium of each of the user terminals 85, 86, and 87, and a layer associated with the storing portion is defined (step S32). For the storing portions, a predetermined number of storing portions having a predetermined area may be pre-allocated to store the content of the web documents. Alternatively, the storage capacity corresponding to the sizes of the web documents may be dynamically allocated for each web document to store the content of each web document in the allocated storing portion. Each of the stored web documents is associated with a layer supported by HTML. The layer, which is a tag supported by HTML extension (or DHTML), is used to perform a function for designating a specific region and displaying the content of the web document therein. Several layers may overlap one other. Using a scripting language such as JavaScript enables the position of the layer to be changed freely or hidden. Furthermore, the overlaid layers can be made transparent. In this embodiment, the features of the layer are used to arrange layers for the plurality of web documents on a screen so that the layers overlap one another. Only the topmost layer is displayed on the screen, and the rest of the layers are made to appear invisible, thereby performing a screen transition from one document to another. Although the layers have been employed in order to display the content of the web documents stored in the storing portions, web document objects such as frame, iframe, division, and span may be used in place of the layer to display the content of web documents on the screen or serve as storing regions for the web documents. It will be apparent that objects or technologies to be developed later for performing the above functions may be used in place of the above objects.

If the plurality of secondary web documents are stored in the individual storing portions and the layers associated therewith are defined, a document selector associated with each layer is displayed on a multi-browser window 300 (step S33). To implement a multi-browse function for each of the plurality of secondary web documents, the following variables may be defined. Here, it is assumed that n secondary web documents are multi-browsed. Since objects and scripts will be described herein solely for explanation, they are not written according to correct grammar rules:

homeUrl: address of a home page document (primary document)

multibrowseUrl[n]: address of multi-browse document (the address of a third document is multibrowseUrl[2])

multibrowseName[n]: name of multi-browse document (the name of a fourth document is multibrowseName[3])

multibrowselndex: variable storing what multi-browse document is currently selected (the variable has a value between 0 and (n−1))

If secondary documents are loaded using frames and there are no other frames in the primary document, document,frames represents multi-browse document windows.

document.frames[multibrowselndex]: a frame in which a currently selected multi-browse document appears

document.all.layer[i] represents layer of a multi-browse document

document.all.layer[multibrowseIndex]: layer in which a currently selected multi-browse document appears.

For example, using the above variables, a code for a document selector may appear in the form of:

<span name=“docTitle3”onMouseOver=“Select(3)”>

value of MulbrowseName[3]

</span>

If the document selectors appears on the screen and the user selects one of them by, for example, positioning a mouse cursor over the document selector, a Select function is executed by the phrase ‘onMouseOver=“Select(3)”’ to display the layer associated with the document selector selected by the user on the screen (step S34). A code of the Select function may appear as follows:

function Select(i) {
document.all.layer[multibrowseIndex].visibility=invisible; (a layer of

a previously selected document is made invisible)

multibrowseIndex=i;
document.all.layer[multibrowseIndex].visibility=visible; (a layer of a

currently selected document is made visible)

}

That is, if one of the document selectors is selected, the document selector transfers its identifier to the Select function as a variable i. The Select function receives the variable i (that is, identifier of the selected document selector) as a factor, thereby making a layer corresponding to a previously selected secondary web document invisible while making a layer corresponding to a currently selected document selector visible. Since all of the n secondary web documents overlap one another at a specific region as described above, if the Select function is performed, the user recognizes that the secondary web document displayed on the multi-browser window 300 is instantaneously switched to another document.

If only a layer corresponding to one of the secondary web documents appears on the screen, the user performs a variety of browse functions on the layer (step S35). In this case, manipulating back, forward, stop, and reload buttons on a control bar 35 affects only the secondary web document displayed on the layer. For example, some of functions of the control bar 35 may be implemented as follows using JavaScript:

1) home document.location.href=homeURL;

2) back document.frame[multibrowseIndex].location.history(−1);

3) forward document.frames[multibrowseIndex].location.history(+1);

4) reload document.frames[multibrowseIndex].location.reload( );

The manipulation of back, forward, stop, and reload buttons affects only the secondary web document displayed on the multi-browser window 300. On the other hand, the manipulation of open new window and erase buttons on a control bar 35 affects the management of the secondary web documents. That is, clicking on the open new window button generates a new browser window and displays the secondary web document appearing on the current multi-browser window 300 on the newly generated browser window. The browser window takes on the form of a conventional browser window. Clicking on the erase button deletes the secondary web document displayed on the current multi-browser window 300. At the same time, the document selector associated with the deleted secondary web document is also deleted, and a secondary web document associated with a document selector next to the deleted document selector in the document selecting portion 200 is displayed on the multi-browser window 300.

Monitoring as to whether the user selects another document selector while browsing on the selected layer is continuously made. It is determined whether another document selector is selected (step S36). If another document selector is selected, the process returns to the step S34 to cause a layer corresponding to the document selector selected by the user to appear on the screen. Conversely, if the other document is not selected, the process returns to the step S35 and a variety of browse function continue to be performed on the layer. It should be noted that, if the other document selector is selected to change the type of the secondary web document displayed on the screen, the content of the previous secondary web document is not deleted but made invisible to the user while maintaining the content thereof. That is, if the document selector corresponding to the previous secondary web document is selected again, the previous status of the secondary web document is displayed in place of an initialized document. This can be very effectively used in executing a task by referencing a plurality of web documents.

As described above, the secondary web documents to be browsed may be predesignated by the user. FIG. 5 shows an example of a multilink location creation screen according to a first embodiment of the present invention. Referring to FIG. 5, a multilink location creation window includes a title 92 representing that the window is provided for creating multilink locations, a URL input portion 93 for entering the URL of a secondary web document to be multi-browsed, a name input portion 94 for entering a name to be used as a document selector for the secondary web document, a description input portion 95 for entering a brief description for the secondary web document. If the user clicks on a multi-link location creation button 96 after entering inputs into the URL input portion 93, a name input portion 94, and the description input portion 95, the relevant web document is designated as a secondary web document to be multi-browsed. If the user is connected to the web document processing apparatus 80 later, the web documents described on the multilink location creation screen are automatically stored in bulk in the storing portions of the user terminals 85, 86, and 87 without extra manipulation by the user, and one of the secondary web documents is displayed on the screen of the user terminals 85, 86, and 87. An example of a code for displaying the n web documents in bulk on a layer is given below (an inline frame (iframe) is used in the code):

<script>
for (i = 0; i < n; i++) {
document.write(“<iframe src=”+multibrowseUrl[i] + “></iframe>”0;
}
</script>

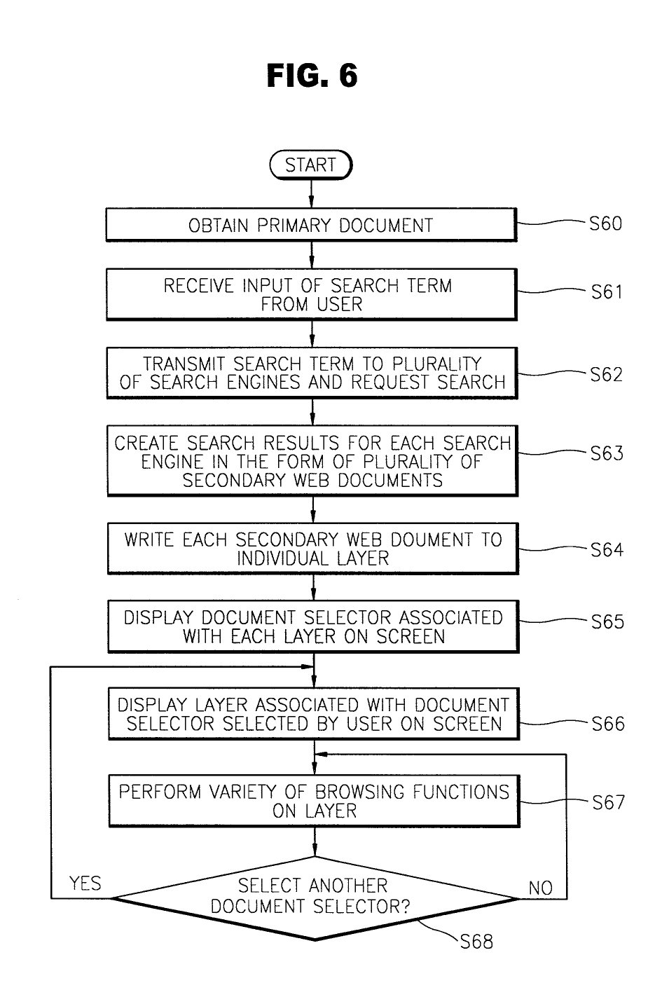

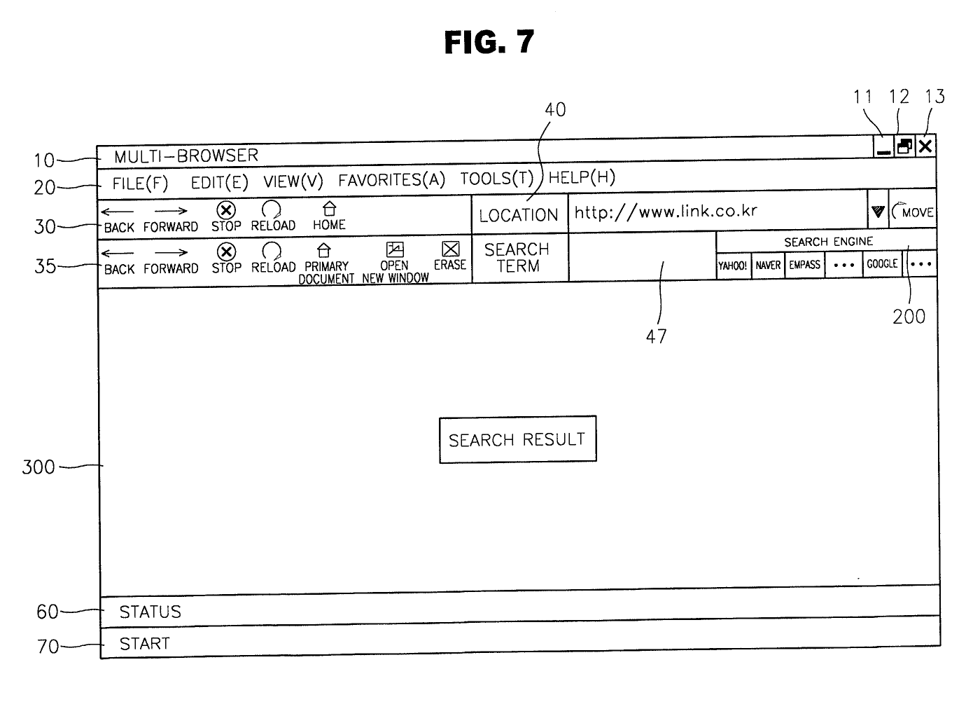

In the method for web document processing according to the first embodiment of the present invention, the secondary web documents are created by specifying specific URLs of the web sites containing the secondary web documents. However, the secondary web documents may be generated by using a plurality of results processed by predetermined data provided from the user instead of specifying the content contained in the URLs thereof. A method for web document processing according to a second embodiment of the present invention involves generating secondary web documents by designation using a plurality of results processed by data. That is, the method for web document processing according to the second embodiment of this invention involves receiving a plurality of search results for a search term from a plurality of search engines and multi-browsing the plurality of search results. The method for web document processing according to the second embodiment of this invention will now be described with reference to FIGS. 6 and 7. FIG. 6 is a flowchart of the method for web document processing using a multi-browse function according to the present invention, and FIG. 7 is an example of a multi-browser screen according to a second embodiment of this invention.

First, a search term is input from the users 88, 89, and 90 through a search term input portion 47 (step S61). A search request is made by transmitting the search term to a plurality of predetermined search engines (step S62). The type of search engine is predefined by the web document processing apparatus 80. However, the user may add other search engines (not shown in the drawings) by using a script language having a predetermined format suitable for those search engines. Since techniques for transmitting the search term to each of the plurality of search engines and requesting a search for the search term will become evident to those skilled in the art, a detailed explanation thereof will be omitted. Each search engine makes a search on the search term to provide results of the search to the primary document 802. The primary document 802 creates the search results in the form of secondary web documents for each search engine (step S63). That is, the search result of the single search term is formed in the form of a separate web document for each search engine. If a plurality of web documents have been created in this way, the steps S64 through S68 are performed. Steps S64 through S68 are the same as their counterparts in the first embodiment, and detailed descriptions thereof will be omitted. For the name of a document selector selected by the user, the name of a search engine may be used (see a search engine selecting portion 250 of FIG. 7).

Codes for performing a multi-browse function according to this embodiment are written in a programming language for Web documents such as HTML (or DHTML) including a script language, PHP, ASP, or XML or in a high-level programming language such as Java, C, C++, or BASIC. In addition to the codes, multimedia objects such as graphic (still) images, audio, and animation may be used. The codes and the multimedia objects are stored in a storage unit of a web server system such as a memory working as a cache, an HDD or an optical recording medium. The program code used in the method for web document processing using a multi-browse function according to the present invention are recorded as the primary document 802 of the web document processing apparatus 80. The program code may be executed at various positions. That is, the program code may be written in the form of a server-side program executed directly by the web document processing apparatus 80 by using programs such as PHP, ASP, and JSP. In contrast, the program code may be written in a Java or JavaScript language to be executed on the client-side, i.e., a user terminal. Furthermore, the program code may be incorporated into a web browser by using a general purpose program such as C, C++, or BASIC.

As described in the above embodiments, multimedia objects such as graphic (still) images, audio, and animation as well as texts written in HTML(or dynamic HTML) including a script language, PHP, ASP, JSP, or XML may be used as a secondary web document displayed through multi-browsing. A client-side terminal applied to the present invention, that is, a user terminal, is a computer-based apparatus capable of making a connection to the Internet (for Internet communications) such as a PC, a web TV, a PDA, a web phone, or a mobile telecommunication device. A web browser applied to the present invention is a web navigation program used in a computer device.

Furthermore, while this invention has been described with respect to preferred embodiments, if a web editor (for example, a NAMO web editor or a Microsoft Front Page) includes a multi-browse feature, this falls within the scope of the appended claims. That is, if an editor selects a multi-browse function while editing a link and the output file of the editor has a multi-browse function, i.e., if the overall process is performed by an editor program, this falls within the scope of the appended claims of this invention.

As described above, a method and apparatus for processing web documents using a multi-browse function according to this invention enable users to view a plurality of documents or search results without moving from one web page to another, thereby saving surfing time on the Internet and increasing effective use of the Internet.

While this invention has been particularly shown and described with reference to a preferred embodiment thereof, it will be understood by those skilled in the art that various changes in form and details may be made therein without departing from the spirit and scope of the invention as defined by the appended claims.

What is claimed is:

1. A method for web document processing using a multi-browsing function for incorporating and browsing a plurality of web documents at a terminal connected to a server through a network, the method comprising the steps of:
obtaining web documents including at least a primary document;
obtaining one or more secondary web documents from the primary document;
storing data of the secondary web documents in corresponding predetermined storing portions;
displaying document selectors associated with the secondary web documents on a screen of the terminal; and
upon selecting one of the document selectors, displaying a secondary web document corresponding to a selected document selector on the screen of the terminal.

2. The method of claim 1, wherein the primary document is indicated by a Uniform Resource Locator (URL).

3. The method of claim 1, wherein the primary document creates, deletes, and switches the secondary web documents.

4. The method of claim 1, further comprising the step of deleting data of a previous secondary web document stored in a storing portion, recording the content of a new secondary web document on the storing portion, and displaying the new secondary web document on the screen when another new secondary web document is obtained through a link on the secondary web document displayed on the screen of the terminal.

5. The method of claim 1, wherein the secondary web documents are generated by specifying URLs of web sites containing the secondary web documents.

6. The method of claim 1, wherein the secondary web documents are generated by using a plurality of results processed based on data input or selected by a user.

7. The method of claim 6, wherein generating the secondary web documents that indicate the result of a search made by a plurality of search engines comprises the steps of:
receiving a search term from a user;
providing the search term to a plurality of search engines and making a search request;
receiving the results of the search from the plurality of search engines and designating the results of the search as the secondary web documents.

8. The method of claim 1 or 7, wherein the web page of the server displayed on the screen of the terminal includes at least one of a separate location/URL input area and a search term input area and a virtual browser window where the secondary web documents are superimposed in layers.

9. The method of claim 8, wherein the plurality of secondary web documents are stored in association with objects such as frame, inline frame (iframe), layer, division, and span, and if a select event for the objects occurs, a selected object is displayed on the virtual browser window.

10. The method of claim 1, wherein the secondary web documents includes two types of documents: documents predesignated and provided to the user and documents designated by the user during browsing.

11. The method of claim 10, wherein the secondary web documents predesignated and provided to the user are designated by the server and/or the user.

12. The method of claim 10, wherein the secondary web documents designated by the user during browsing are designated by entering Internet Protocol (IP) addresses or domain names or clicking on a hypertext linked to a web document, or they are designated according to an input result submitted through an input form contained in a predetermined web document.

13. The method of claim 1, wherein data of the plurality of secondary web documents are automatically stored in the storing portions during web browsing without extra manipulation by the user.

14. The method of claim 1, wherein the web document processing method is implemented with a script and/or general purpose program to be executed on the terminal.

15. An apparatus for web document processing including a multi-browsing function for incorporating and browsing a plurality of web documents at a terminal connected to a server through a network, the apparatus comprising:
a module for obtaining web documents containing at least a primary document;
a module for obtaining one or more secondary web documents specified in the primary document;
a module for storing data of the secondary web documents in corresponding predetermined storing portions;
a module for displaying document selectors in association with the secondary web documents on a screen of the terminal; and
a module for displaying a secondary web document stored in the corresponding storing portion corresponding to one of the document selectors selected on the screen of the terminal.

16. The apparatus of claim 15, wherein the primary document is indicated by a Uniform Resource Locator (URL).

17. The apparatus of claim 15, wherein the primary document creates, deletes, and switches the secondary web documents.

18. The apparatus of claim 15, wherein when another new secondary web document is obtained through a link on the secondary web document displayed on the screen of the terminal, data of a previous secondary web document stored in the storing portion is deleted, the content of the new secondary web document is recorded on the storing portion, and the new secondary web document is displayed on the screen.

19. The apparatus of claim 15, wherein the secondary web documents are generated by specifying URLs of web sites containing the secondary web documents.

20. The apparatus of claim 15, wherein the secondary web documents are generated by using a plurality of results processed based on data input or selected by a user.

21. The apparatus of claim 20, wherein the web document processing apparatus comprises a multiple search module that receives a search term from a user, provides the search term to a plurality of search engines and makes a search request, receives the results of the search from the plurality of search engines, and designates the results of the search as the secondary web documents.

22. The apparatus of claim 15 or 21, wherein the web page of the server displayed on the screen of the terminal includes at least one of a separate location/URL input area and a search term input area and a virtual browser window where the secondary web documents are superimposed in layers.

23. The apparatus of claim 22, wherein the plurality of secondary web documents are stored in association with objects such as frame, inline frame (iframe), layer, division, and span, and if a select event for the objects occurs, a selected object is displayed in the virtual browser window.

24. The apparatus of claim 15, wherein the secondary web documents includes two types of documents: documents predesignated and provided to the user and documents designated by the user during browsing.

25. The apparatus of claim 24, wherein the secondary web documents predesignated and provided to the user are designated by the server and/or the user.

26. The apparatus of claim 24, wherein the secondary web documents designated by the user during browsing are designated by entering Internet Protocol (IP) addresses or domain names or clicking on a hypertext linked to a web document, or they are designated according to an input result submitted through an input form contained in a predetermined web document.

27. The apparatus of claim 15, wherein the web document processing apparatus is implemented as a script and/or general purpose program to be executed on the terminal.

28. The apparatus of claim 15, wherein the terminal is a PC-based client-server system, a web TV, a Personal Digital Assistant (PDA), or a web phone.

29. The apparatus of claim 15, wherein data of the plurality of secondary web documents are automatically stored in the storing portions during web browsing without extra manipulation by the user.

30. A computer readable recording medium on which a web document processing method for incorporating and browsing a plurality of web documents at a terminal connected to a server through a network is recorded, wherein the web browsing processing method comprises the steps of:
obtaining web documents including at least a primary document;
obtaining one or more secondary web documents specified in the primary document;
storing data of the secondary web documents in corresponding predetermined storing portions;
displaying document selectors associated with the secondary web documents on a screen of the terminal; and
upon selecting one of the document selectors, displaying a secondary web document corresponding to the selected document selector on the screen of the terminal.

31. A method for web document processing for performing web browsing at a terminal for Internet communications, the method comprising the steps of:
opening and loading a plurality of web documents together;
loading the plurality of web documents into different objects such as layers or frames;
upon selecting one of the plurality of web documents, displaying a selected web document on a multi-browser window while making a current layer invisible from the window;
upon entering a URL into a location window of the multi-browser window, changing a document of a current object displayed on the multi-browser window to a document of a location identified by the input URL; and
affecting the document of the current object displayed on the multi-browser window when clicking on forward, back, and reload buttons.

32. A web browser executed on a terminal connected through a network for incorporating and browsing a plurality of web documents, wherein the web browser obtains one or more web documents, stores data of the obtained web documents in corresponding predetermined storing portions, displays document selectors associated with the web documents, and upon selecting one of the document selectors, displays a web document stored in the storing portion corresponding to the document selector on a screen of the terminal.

33. A web page for providing a multi-browsing function to a user accessing the web page through a terminal capable of Internet communications, wherein the web page comprises a document selecting portion for displaying a plurality of web documents on a web browser at once so that a user can select one of the plurality of web documents, and wherein the web page comprises a multi-browser window for displaying an object of the selected web document while clearing a previous web document.
